(19) United States
(12) Patent Application Publication
(10) Pub. No.: US 2026/0185662 A1
(43) Pub. Date: Jul. 2, 2026

(54) Underground Gas Storage Device for Compressed Air Energy Storage and Construction Method Thereof

(71) Applicant: Shanghai Investigation, Design & Research Institute Co., Ltd., Shanghai (CN)

(72) Inventors: Rui WEN, Shanghai (CN); Lei GUO, Shanghai (CN); Yujie TANG, Shanghai (CN); Fangyong ZHANG, Shanghai (CN); Yujun MA, Shanghai (CN); Jiadeng LIANG, Shanghai (CN); Yongqi DAI, Shanghai (CN); Lin ZHAO, Shanghai (CN); Ming MENG, Shanghai (CN)

(73) Assignee: Shanghai Investigation, Design & Research Institute Co., Ltd., Shanghai (CN)

(21) Appl. No.: 18/842,811

(22) PCT Filed: Dec. 8, 2023
(86) PCT No.: PCT/CN2023/137556

§ 371 Date: Mar. 9, 2026

(30) Foreign Application Priority Data
Jul. 4, 2023 (CN) 202310810264.2

(51) Int. Cl. F17C 1/00

(52) U.S. Cl. CPC F17C 1/007; F17C 2201/0104; F17C 2203/012; F17C 2203/0621; F17C 2203/0639; F17C 2203/0678; F17C 2205/0352; F17C 2209/232; F17C 2221/031; F17C 2270/0149

(57) ABSTRACT

An underground gas storage device includes an underground gas storage chamber, which is formed by multiple segments. A connecting passage is provided between two non-adjacent segments. On the outer top wall of the connecting passage is a shaft. At the intersection of the shaft and the connecting passage is a sealing plug. An inlet pipe and an outlet pipe are provided within the shaft. An outer bottom wall of the connecting passage is provided with a sump. A first drainage ditch is arranged along the circumference of the top edge of the sealing plug. The first drainage ditch communicates with the sump. On the outer surface of the segments is a drainage blind pipe assembly. The drainage blind pipe assembly communicates with the sump. The present invention allows for excavation in one go, reducing construction difficulty, and effectively minimizes the impact of groundwater on the underground gas storage chamber.

### FIELD OF THE INVENTION

The present invention belongs to the technical field of underground structural engineering, and specifically relates to an underground gas storage device for compressed air energy storage and a construction method thereof.

### BACKGROUND OF THE INVENTION

Compressed air energy storage (CAES) power plants primarily work in conjunction with wind power, tidal power, and hydropower. They convert excess electrical energy from the grid during off-peak periods into the potential energy of compressed air stored in storage devices. During peak electricity demand periods, compressed air is used to generate electricity, effectively mitigating the intermittency and random fluctuations of renewable energy power generation and improving the utilization rate of renewable energy power generation. CAES is a power storage technology capable of large-capacity and long-duration energy storage.

Additionally, compared to pumped storage hydropower, storage devices for CAES have shorter construction periods, are less restricted by geographical conditions, and allow flexible layout options. Compared to electrochemical storage, CAES has advantages such as larger capacity, longer discharge duration, higher safety, lower environmental pollution, and better adaptability to high and low temperatures. Furthermore, the storage devices used in CAES have a long lifetime.

However, existing CAES projects face the following issues: 1) For CAES projects with underground storage devices, based on different geological structures, the underground storage devices include mined or specially excavated salt caverns, mined underground gas or oil storage caverns, and manually excavated underground chambers. Except for manually excavated underground chambers, other underground storage devices can be directly used for storing compressed gas, but they are costly and their use is limited by geological conditions. Additionally, non-standard-shaped underground storage devices make the stress deformation analysis difficult. As for manually excavated underground chambers, complex construction conditions and high technical difficulty are usually involved. 2) For CAES projects with above-ground storage devices, the fabrication of large-span, long-distance above-ground pipelines is challenging, expensive, and poses high safety risks. Furthermore, since the pressure within the storage devices often exceeds 10 MPa, the thickness of the sealing steel according to pressure vessel design standards needs to exceed 5 cm, making fabrication difficult and the overall cost very high.

### SUMMARY OF THE INVENTION

The present invention provides an underground gas storage device for compressed air energy storage and its construction method, which allows for excavation in one go without structural reconstruction, reducing construction difficulty. The present invention further effectively minimizes the impact of groundwater on the underground gas storage chamber during construction, operation, and maintenance periods.

The technical solution adopted by the present invention is as follows.

The present invention provides an underground gas storage device for compressed air energy storage. The underground gas storage device for compressed air energy storage comprises an underground gas storage chamber embedded in the surrounding underground rock, wherein the underground gas storage chamber includes multiple sequentially connected underground-gas-storage-chamber segments. A connecting passage is provided between two non-adjacent underground-gas-storage-chamber segments. A shaft is provided on an outer top wall of the connecting passage, and a sealing plug is provided at the intersection of the shaft and the connecting passage. An inlet pipe and an outlet pipe are provided within the shaft, and the lower ends of the inlet pipe and the outlet pipe both pass through the sealing plug and connect to the connecting passage. A sump is provided at the outer bottom wall of the connecting passage. A first drainage ditch is provided along the circumference of the top edge of the sealing plug within the shaft, and the first drainage ditch is connected to the sump via a first drainage pipe. A drainage blind pipe assembly is provided on an outer surface of the underground-gas-storage-chamber segments, and the drainage blind pipe assembly is connected to the sump via a second drainage ditch provided at the outer bottom wall of the connecting passage.

In one embodiment, the underground-gas-storage-chamber segments are cylindrical, adjacent underground-gas-storage-chamber segments are integrally connected with an arcuate connection, and the connecting passage is integrally connected to the corresponding underground-gas-storage-chamber segments.

In one embodiment, the inlet pipe is a three-way pipe, including a vertically arranged first section of inlet pipe and two horizontally arranged second sections of inlet pipe. An upper part of the first section of inlet pipe is located within the shaft and a lower part of the first section of inlet pipe is located within the sealing plug, wherein the sealing plug is at the lower part of the shaft. One of the second sections of inlet pipe is situated within one side of the sealing plug, and the other one of the second sections of inlet pipeline is situated within the other side of the sealing plug. One end of each second section of inlet pipe is connected to a lower end of the first section of inlet pipe, and the other end of each second section of inlet pipe passes through the sealing plug and communicates with the connecting passage.

In one embodiment, the outlet pipe has the same structure as the inlet pipe. The outlet pipe includes a vertically arranged first section of outlet pipe and two horizontally arranged second sections of outlet pipe. The outlet pipe is further used as an inspection pipe, an inspection port is provided at the first section of outlet pipe near the top surface of the sealing plug, and the inspection port is equipped with a blocking blind plate.

In one embodiment, a second drainage pipe is also provided within the shaft, a lower end of the second drainage pipe extends into the sump and an upper end of the second drainage pipe extends to a surface of the ground and is connected to a pump.

In one embodiment, the sump is located at the outer bottom wall of the connecting passage, which is located below the shaft. The first drainage pipe passes through the sealing plug and the lower end of the first drainage pipe extends into the sump. The second drainage ditch is arranged along an extension direction of the connecting passage and is provided on the outer bottom wall of the connecting passage, and a lower part of the second drainage pipe passes through the sealing plug.

In one embodiment, the drainage blind pipe assembly includes multiple circumferential drainage blind pipes and multiple longitudinal drainage blind pipes, wherein the circumferential drainage blind pipes are arranged circumferentially around the outer surface of the underground-gas-storage-chamber segments. The axes of the longitudinal drainage blind pipes are parallel to the axes of the underground-gas-storage-chamber segments and are positioned at corresponding locations on the outer surface of the underground-gas-storage-chamber segments. The longitudinal drainage blind pipes located at the bottom of the outer surface of the underground-gas-storage-chamber segments are referred to as bottom longitudinal drainage blind pipes. Each circumferential drainage blind pipe is connected to each longitudinal drainage blind pipe. The bottom longitudinal drainage blind pipes of the underground-gas-storage-chamber segments that are connected to the connecting passage are connected to the second drainage ditch.

In one embodiment, the elevation of the bottom of two ends of the underground-gas-storage-chamber segments that are connected to the connecting passage is higher than the elevation at the bottom of the points where the underground-gas-storage-chamber segments are connected to the connecting passage.

In one embodiment, the underground-gas-storage-chamber segments comprise, from outside to inside, a sprayed concrete layer, a reinforced concrete lining layer, and a sealing layer, wherein the sealing layer is formed by sequentially welding multiple steel plates.

A construction method for the underground gas storage device for compressed air energy storage, comprising:

S1, forming the shaft by excavation; after the shaft is completed, forming the connecting passage along two directions of the shaft by excavation, wherein the shaft serves as a center of the connecting passage; forming the sump at the outer bottom wall of the connecting passage and forming the second drainage ditch along the outer bottom wall of the connecting passage; after the connecting passage is completed, forming the underground-gas-storage-chamber segments that are connected to the connecting passage by excavation; then, forming the underground-gas-storage-chamber segments that are not connected to the connecting passage by excavation; arranging the drainage blind pipe assembly around the outer circumference of the underground-gas-storage-chamber segments and connecting the drainage blind pipe assembly to the second drainage ditch;

S2, after all the underground-gas-storage-chamber segments are excavated, constructing the sprayed concrete layer, the reinforced concrete lining layer, and the sealing layer from outside to inside of the underground-gas-storage-chamber segments; providing the sealing plug at the intersection of the shaft and the connecting passage; providing the inlet pipe and the outlet pipe within the shaft, wherein the lower ends of the inlet pipe and the outlet pipe pass through the sealing plug and communicate with the connecting passage; connecting the first drainage ditch disposed along the circumference of the top edge of the sealing plug within the shaft to the sump via the first drainage pipe.

The present invention has the following beneficial effects.

The underground gas storage device for compressed air energy storage of the present invention makes full use of the strength of the surrounding underground rock to resist internal pressure since the underground gas storage chamber is embedded in the surrounding underground rock. This reduces the investment cost for sealing materials and support engineering. Additionally, the sump located at the outer bottom wall of the connecting passage and the first drainage ditch along the circumference of the top edge of the sealing plug inside the shaft, which connects to the sump via the first drainage pipe, effectively drain accumulated water from the shaft, thus ensuring the durability of the facilities within the shaft. The outer surface of the underground-gas-storage-chamber segments is provided with a drainage blind pipe assembly, which connects to the sump through a second drainage ditch located at the outer bottom wall of the connecting passage. This effectively reduces the impact of groundwater on the underground gas storage chamber during construction, operation, and maintenance periods. Additionally, the shaft is first formed by excavation, once the shaft is completed, the connecting passage is formed by excavation along two directions of the shaft, wherein the shaft is the center of the connecting passage. After the connecting passage is completed, the underground-gas-storage-chamber segments that are connected to the connecting passage are formed by excavation, followed by the formation of other underground-gas-storage-chamber segments that are not connected to the connecting passage by excavation. This uses the shaft as the construction access for the underground gas storage chamber, eliminating the need for additional construction access, thereby accelerating the construction progress and saving construction investment. Compared to using existing underground chambers as gas storage chambers, the underground gas storage device for compressed air energy storage of the present invention can be excavated in one go without the need for structural reconstruction, resulting in relatively lower construction difficulty and better control over construction risks.

In the present invention, the underground-gas-storage-chamber segments are cylindrical, with adjacent underground-gas-storage-chamber segments integrally connected and having an arcuate connection. Similarly, the connecting passage is integrally connected to the corresponding underground-gas-storage-chamber segments with an arcuate connection. This results in the underground-gas-storage-chamber segments having a circular cross-section, which provides favorable stress conditions. Additionally, since the underground gas storage chamber is formed by sequentially connecting multiple cylindrical underground-gas-storage-chamber segments, the layout of the underground gas storage chamber is flexible, allowing for positional adjustments. Good airflow connectivity reduces the dependency on geological conditions to a certain extent.

In the present invention, the inlet pipe is a three-way pipe, including a vertically arranged first section of inlet pipe and two horizontally arranged second sections of inlet pipe. The upper part of the first section of inlet pipe is located within the shaft, while the lower part of the first section of inlet pipe is located within the sealing plug which is at the lower part of the shaft. One of the second sections of inlet pipe is located within the sealing plug on one side of the shaft, and the other second section of inlet pipe is located within the sealing plug on the other side of the shaft. One end of each second section of inlet pipe is connected to the lower end of the first section of inlet pipe, and the other end of each second section of inlet pipe passes through the sealing plug and connects to the connecting passage. This allows the compressed air entering the first section of inlet pipe to be distributed through the two second sections of inlet pipe into the connecting passages, thereby quickly entering the underground gas storage chamber.

In the present invention, since the outlet pipe has the same structure as the inlet pipe, the outlet pipeline includes a vertically arranged first section of outlet pipe and two horizontally arranged second sections of outlet pipe. This allows the compressed air in the underground gas storage chamber to quickly enter the first section of outlet pipe through the two second sections of outlet pipe after entering the connecting passages. The outlet pipe is also used as an inspection pipe, with an inspection port in the first section of outlet pipe near the top surface of the sealing plug. This inspection port is equipped with the blocking blind plate. When maintenance is required for the underground gas storage chamber, workers can enter the shaft and open the blocking blind plate. They then pass through the first section of outlet pipe and the second section of outlet pipe to enter the connecting passage, and from there, access the underground gas storage chamber to carry out the maintenance work. Additionally, since the outlet pipe is also used as the inspection pipe, the amount of construction work is reduced.

In the present invention, the drainage blind pipe assembly includes multiple circumferential drainage blind pipes and multiple longitudinal drainage blind pipes. The circumferential drainage blind pipes are arranged around the outer surface of the underground-gas-storage-chamber segments in a circular pattern. The axes of the longitudinal drainage blind pipes are parallel to the axes of the underground-gas-storage-chamber segments. The longitudinal drainage blind pipes are positioned at corresponding locations on the outer surface of the underground-gas-storage-chamber segments. The longitudinal drainage blind pipes located at the bottom of the outer surface of the underground-gas-storage-chamber segments are referred to as the bottom longitudinal drainage blind pipes. Each circumferential drainage blind pipe is connected to each longitudinal drainage blind pipe. The bottom longitudinal drainage blind pipes of the underground-gas-storage-chamber segments that are connected to the connecting passage are connected to the second drainage ditch. This allows groundwater at the underground-gas-storage-chamber segments to flow sequentially through the circumferential drainage blind pipes and the longitudinal drainage blind pipes (excluding the bottom longitudinal drainage blind pipes) and then into the bottom longitudinal drainage blind pipes. Groundwater in the bottom longitudinal drainage blind pipes of the underground-gas-storage-chamber segments that are not connected to the connecting passage can flow into the bottom longitudinal drainage blind pipes of the underground-gas-storage-chamber segments that are connected to the connecting passage. Groundwater in the bottom longitudinal drainage blind pipes of the underground-gas-storage-chamber segments that are connected to the connecting passage can then flow through the second drainage ditch into the sump, thus quickly draining groundwater from the underground-gas-storage-chamber segments into the sump.

### BRIEF DESCRIPTION OF DRAWINGS

FIG. 1 is a three-dimensional structural diagram of an underground gas storage device for compressed air energy storage in the present invention.

FIG. 2 is a top cross-sectional view of the underground gas storage device for compressed air energy storage in the present invention.

FIG. 3 is an enlarged view of section B in FIG. 2.

FIG. 4 is a cross-sectional view of the underground gas storage device for compressed air energy storage along the A-A direction in FIG. 2.

FIG. 5 is an enlarged view of a portion of FIG. 4.

FIG. 6 is an enlarged cross-sectional view of an underground-gas-storage-chamber segment.

### REFERENCE NUMERALS

1. Underground gas storage chamber
101. Underground-gas-storage-chamber segment
1011. Sprayed concrete layer
1012. Reinforced concrete lining layer
1013. Sealing layer
2. Connecting passage
3. Shaft
4. Sealing plug
5. Inlet pipe
6. Outlet pipe
601. First section of outlet pipe
602. Second section of outlet pipe
7. Sump
8. First drainage ditch
9. First drainage pipe
10. Second drainage ditch
11. Blocking blind plate
12. Second drainage pipe
13. Circumferential drainage blind pipe
14. Longitudinal drainage blind pipe
15. Bottom longitudinal drainage blind pipe
16. Passing bay

### DETAILED DESCRIPTION OF THE INVENTION

The specific embodiments of the present invention will be further described in detail below in conjunction with the accompanying drawings. These embodiments are provided to illustrate the present invention and are not intended to limit the scope of the present invention.

In the description of the present invention, it should be noted that the terms “center,” “longitudinal,” “transverse,” “upper,” “lower,” “front,” “rear,” “left,” “right,” “vertical,” “horizontal,” “top,” “bottom,” “inner,” “outer,” and other positional or directional indications are based on the orientation or positional relationship shown in the accompanying drawings. These terms are used for convenience of description and simplification, and do not indicate or imply that the referred devices or elements must have specific orientations, be constructed in a particular orientation, or be operated in a particular orientation. Therefore, they should not be understood as limiting the present invention. Additionally, the terms “first” and “second” are used for descriptive purposes only and should not be construed as indicating or implying relative importance.

In the description of the present invention, it should be noted that, unless explicitly defined and limited otherwise, the terms “installation,” “connected,” and “communicated” should be broadly understood. For example, they can be fixed connections, detachable connections, or integral connections; they can be mechanical connections or electrical connections; they can be direct connections or indirect connections through intermediate media, or they can be internal communications between two elements. For those skilled in the art, the specific meanings of the above terms in the present invention can be understood according to specific situations.

Additionally, in the description of the present invention, the term “multiple” means two or more unless otherwise specified.

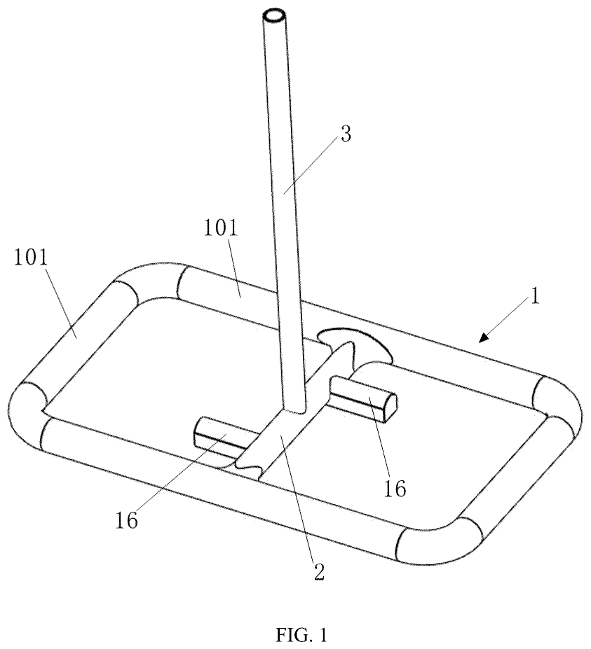

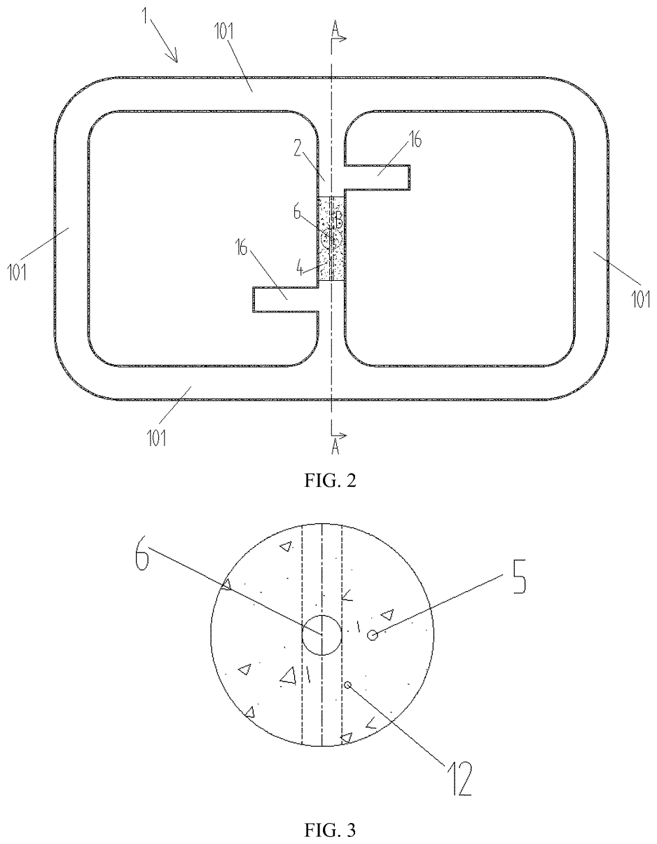

As shown in FIGS. 1-5, an underground gas storage device for compressed air energy storage is provided. The underground gas storage device includes a tunnel-type underground gas storage chamber 1 embedded in the surrounding underground rock. The underground gas storage chamber 1 includes multiple sequentially connected underground-gas-storage-chamber segments 101. A connecting passage 2 is provided between two non-adjacent underground-gas-storage-chamber segments 101. On the outer top wall of the connecting passage 2 is a shaft 3 that extends to the surface of the ground and communicates with the connecting passage 2. At the intersection of the shaft 3 and the connecting passage 2 is a sealing plug 4. An inlet pipe 5 and an outlet pipe 6 are provided within the shaft 3. The lower ends of the inlet pipe 5 and the outlet pipe 6 both pass through the sealing plug 4 and communicate with the connecting passage 2. An outer bottom wall of the connecting passage 2, which is located below the shaft 3, is provided with a sump 7. A circular first drainage ditch 8 is arranged along the circumference of the top edge of the sealing plug 4 inside the shaft 3. The first drainage ditch 8 communicates with the sump 7 via a first drainage pipe 9, which passes through the sealing plug 4 with its lower end extending into the sump 7. On the outer surface of the underground-gas-storage-chamber segments 101, there is a drainage blind pipe assembly. The drainage blind pipe assembly communicates with the sump 7 through a second drainage ditch 10 located on the outer bottom wall of the connecting passage 2. The second drainage ditch 10 is arranged along the length of the connecting passage 2.

Since the underground gas storage chamber 1 is situated within the surrounding underground rock, it can fully utilize the strength of the surrounding rock to resist internal pressure. This reduces the investment cost of sealing materials and support engineering for the underground gas storage chamber 1. Additionally, as there is the sump 7 at the outer bottom wall of the connecting passage 2, and the circular first drainage ditch 8 along the circumference of the top edge of the sealing plug 4 within the shaft 3, which communicates with the sump 7 via the first drainage pipe 9, the accumulated water within the shaft 3 can be effectively drained, ensuring the durability of the facilities within the shaft 3. Furthermore, as the drainage blind pipe assembly on the outer surface of the underground-gas-storage-chamber segments 101 communicates with the sump 7 via the second drainage ditch 10 located on the outer bottom wall of the connecting passage 2, the impact of groundwater on the underground gas storage chamber 1 during the construction, operation, and maintenance periods can be effectively reduced.

Additionally, before forming the underground gas storage chamber 1 by excavation, the shaft 3 is formed first. Once the shaft 3 is completed, the connecting passage 2 is formed by excavation along two directions with its center as the shaft 3. After the connecting passage 2 is completed, some underground-gas-storage-chamber segments 101 connected to the connecting passage 2 are formed by excavation, followed by the excavation of other underground-gas-storage-chamber segments 101. In this way, the shaft 3 serves as a construction access for the underground gas storage chamber 1, eliminating the need for additional construction access, thereby speeding up the construction progress and saving temporary construction costs. Compared to using existing underground chambers as gas storage chambers, the underground gas storage device for compressed air energy storage in the present invention can be excavated in one go without structural reconstruction, making the construction relatively easier and better for risk control.

In one embodiment, as shown in FIG. 1, the underground-gas-storage-chamber segments 101 are cylindrical, and the adjacent underground-gas-storage-chamber segments 101 are integrally connected with an arcuate connection. The connecting passage 2 is also integrally connected to the corresponding underground-gas-storage-chamber segments 101. This provides the underground-gas-storage-chamber segments 101 with a circular cross-section, which offers good stress conditions. Additionally, since the underground gas storage chamber 1 is formed by multiple sequentially connected cylindrical underground-gas-storage-chamber segments 101, the layout of the underground gas storage chamber 1 is flexible, allowing for positional flexibility and good airflow connectivity. This reduces the dependency on geological conditions to a certain extent. Preferably, the underground gas storage chamber 1 includes four underground-gas-storage-chamber segments 101, and the four underground-gas-storage-chamber segments 101 form a rectangular shape. The connecting passage 2 connects two long segments of the four underground-gas-storage-chamber segments 101 and is positioned in the middle of the rectangular shape formed by the four underground-gas-storage-chamber segments 101. Preferably, the shaft 3 is located at the middle of the outer top wall of the connecting passage 2 and serves as the main access during the construction period and as an inspection passage during the maintenance period for the underground gas storage chamber 1.

In one embodiment, the inlet pipe 5 is a three-way pipe, comprising one vertically arranged first section of inlet pipe and two horizontally arranged second sections of inlet pipe. The upper part of the first section of inlet pipe is inside the shaft 3, while the lower part of the first section of inlet pipe is located within the sealing plug 4, wherein the sealing plug 4 is at the lower part of the shaft 3. One of the second sections of inlet pipe is situated within one side of the sealing plug 4, and the other one of the second sections of inlet pipe is situated within the other side of the sealing plug 4. One end of each second section of inlet pipe is connected to the lower end of the first section of inlet pipe, while the other end of each second section of inlet pipe passes through the sealing plug 4 and communicates with the connecting passage 2.

This allows compressed air from the first section of inlet pipe to be distributed through the two second sections of inlet pipe into the connecting passage 2, thereby quickly entering the underground gas storage chamber 1. The sealing plug 4 prevents the compressed air inside the underground gas storage chamber 1 from directly entering the shaft 3 through the connecting passage 2.

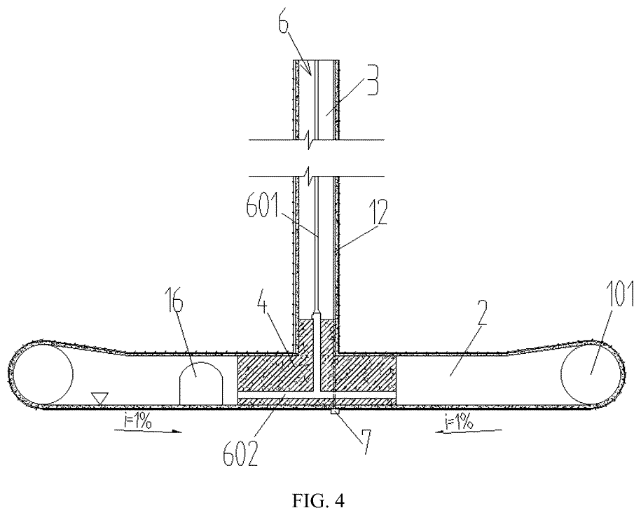

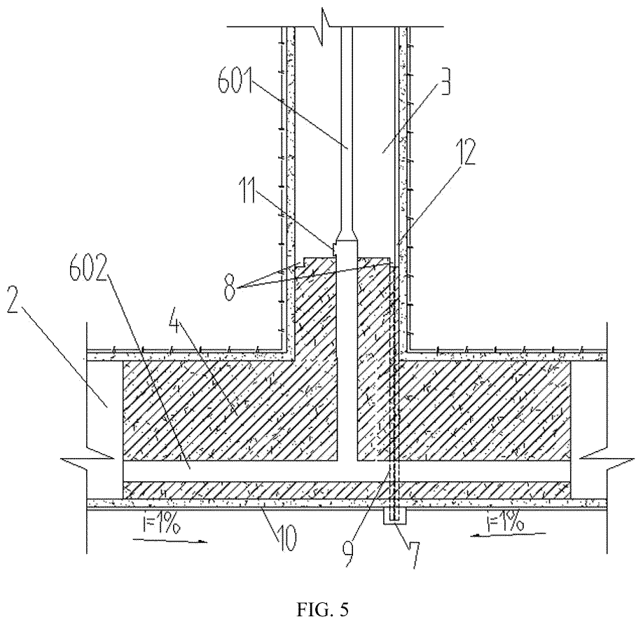

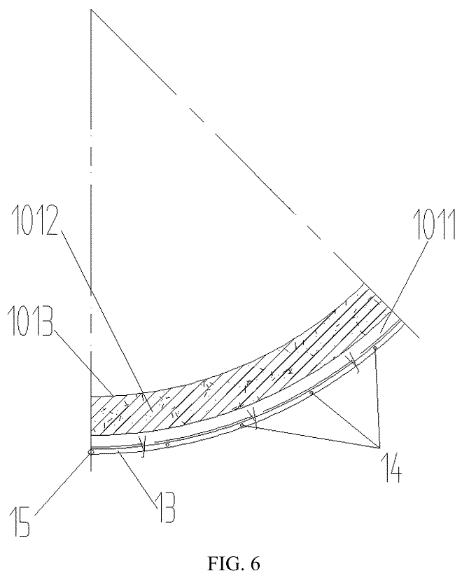

In one embodiment, the outlet pipe 6 has the same structure as the inlet pipe 5. As shown in FIGS. 4-5, the outlet pipe 6 includes a vertically arranged first section of outlet pipeline 601 and two horizontally arranged second sections of outlet pipe 602. Thus, the compressed air inside the underground gas storage chamber 1, after entering the connecting passages 2, can quickly flow through the two second sections of outlet pipe 602 into the first section of outlet pipe 601. The outlet pipe 6 is also used as an inspection pipe, with an inspection port in the first section of outlet pipe 601 near the top surface of the sealing plug 4. This inspection port is equipped with a blocking blind plate 11. When maintenance is required for the underground gas storage chamber 1, workers can enter the shaft 3 and open the blocking blind plate 11. They then pass through the first section of outlet pipe 601 and the second section of outlet pipe 602 to enter the connecting passage 2, and from there, access the underground gas storage chamber 1 to carry out the maintenance work. Additionally, since the outlet pipe 6 is also used as the inspection pipe, the amount of construction work is reduced. The first section of outlet pipe 601 is a variable diameter pipe, with the diameter of the first section of outlet pipe 601 above the inspection port being smaller than the diameter of the first section of outlet pipe 601 below the inspection port. The diameter of the second sections of outlet pipe 602 is equal to the diameter of the first section of outlet pipeline 601 below the inspection port.

In one embodiment, as shown in FIGS. 4-5, a second drainage pipe 12 is also provided within the shaft 3. A lower part of the second drainage pipe 12 passes through the sealing plug 4 and extends into the sump 7, while an upper end of the second drainage pipe 12 extends to the surface of the ground and connects to a pump. This allows the pump to extract groundwater from the sump 7 to the surface of the ground.

In one embodiment, as shown in FIG. 6, the drainage blind pipe assembly includes multiple circumferential drainage blind pipes 13 and multiple longitudinal drainage blind pipes 14. The circumferential drainage blind pipes 13 are arranged around the outer surface of the underground-gas-storage-chamber segments 101 in a circular pattern. The axes of the longitudinal drainage blind pipes 14 are parallel to the axes of the underground-gas-storage-chamber segments 101. The longitudinal drainage blind pipes 14 are positioned at corresponding locations on the outer surface of the underground-gas-storage-chamber segments 101. The longitudinal drainage blind pipes 14 located at the bottom of the outer surface of the underground-gas-storage-chamber segments 101 are referred to as the bottom longitudinal drainage blind pipes 15. Each circumferential drainage blind pipe 13 is connected to each longitudinal drainage blind pipe 14. The bottom longitudinal drainage blind pipes 15 of the underground-gas-storage-chamber segments 101 that are connected to the connecting passage 2 are connected to the second drainage ditch 10. The diameters of the bottom longitudinal drainage blind pipes 15 are larger than those of other longitudinal drainage blind pipes 14. This allows groundwater at the underground-gas-storage-chamber segments 101 to flow sequentially through the circumferential drainage blind pipes 13 and the longitudinal drainage blind pipes 14 (excluding the bottom longitudinal drainage blind pipes 15) and then into the bottom longitudinal drainage blind pipes 15. Groundwater in the bottom longitudinal drainage blind pipes 15 of the underground-gas-storage-chamber segments 101 that are not connected to the connecting passage 2 can flow into the bottom longitudinal drainage blind pipes 15 of the underground-gas-storage-chamber segments 101 that are connected to the connecting passage 2. Groundwater in the bottom longitudinal drainage blind pipes 15 of the underground-gas-storage-chamber segments 101 that are connected to the connecting passage 2 can then flow through the second drainage ditch 10 into the sump 7, thus quickly draining groundwater from the underground-gas-storage-chamber segments 101 into the sump 7.

Additionally, the elevation of the bottom of two ends of the underground-gas-storage-chamber segments 101 that are connected to the connecting passage 2 is higher than the elevation at the bottom of the points where the underground-gas-storage-chamber segments 101 are connected to the connecting passage 2. This allows the groundwater in the bottom longitudinal drainage blind pipes 15 of the underground-gas-storage-chamber segments 101 that are connected to the connecting passage 2 to easily flow into the second drainage ditch 10 by gravity.

In one embodiment, as shown in FIG. 6, the underground-gas-storage-chamber segments 101 include, from the outside to the inside, a sprayed concrete layer 1011, a reinforced concrete lining layer 1012, and a sealing layer 1013. The sealing layer 1013 is formed by sequentially welding multiple steel plates.

In another embodiment, as shown in FIGS. 1, 2, and 4, passing bays 16 are provided on both sides of the connecting passage 2, the passing bays 16 are connected to the connecting passage 2 to facilitate the movement of vehicles and construction machinery within the connecting passage 2.

The present invention further provides a construction method for the underground gas storage device for compressed air energy storage, including the following steps.

S1. Forming the shaft 3 by excavation. After the shaft 3 is completed, forming the connecting passage 2 along two directions of the shaft 3 by excavation, wherein the shaft 3 serves as a center of the connecting passage 2. Forming the sump 7 at the outer bottom wall of the connecting passage 2 and forming the second drainage ditch 10 along the outer bottom wall of the connecting passage 2. After the connecting passage 2 is completed, forming the underground-gas-storage-chamber segments 101 that are connected to the connecting passage 2 by excavation. Then, forming the underground-gas-storage-chamber segments 101 that are not connected to the connecting passage 2 by excavation. Arranging the drainage blind pipe assembly around the outer circumference of the underground-gas-storage-chamber segments 101 and connecting the drainage blind pipe assembly to the second drainage ditch 10.

S2. After all the underground-gas-storage-chamber segments 101 are excavated, forming constructing the sprayed concrete layer 1011, the reinforced concrete lining layer 1012, and the sealing layer 1013 from outside to inside of the underground-gas-storage-chamber segments 101. Then, providing the sealing plug 4 at the intersection of the shaft 3 and the connecting passage 2. Providing the inlet pipe 5 and the outlet pipe 6 within the shaft 3, wherein the lower ends of the inlet pipe 5 and the outlet pipe 6 pass through the sealing plug 4 and connect to the connecting passage 2. Finally, connecting the first drainage ditch 8 along the circumference of the top edge of the sealing plug 4 within the shaft 3 to the sump 7 via the first drainage pipe 9.

In summary, the underground gas storage device for compressed air energy storage of the present invention is safe, has a large storage capacity, is suitable for a wide range of geological conditions, and is cost-effective.

The above description is merely a preferred embodiment of the present invention. It should be noted that those skilled in the art can make various modifications and substitutions without departing from the technical principles of the present invention. These modifications and substitutions should also be considered within the scope of the present invention.

1. An underground gas storage device for compressed air energy storage, comprising an underground gas storage chamber (1) embedded in surrounding underground rock,
wherein the underground gas storage chamber (1) includes multiple sequentially connected underground-gas-storage-chamber segments (101),
wherein a connecting passage (2) is provided between two non-adjacent underground-gas-storage-chamber segments (101), a shaft (3) is provided on an outer top wall of the connecting passage (2), and a sealing plug (4) is provided at the intersection of the shaft (3) and the connecting passage (2),
wherein an inlet pipe (5) and an outlet pipe (6) are provided within the shaft (3), and lower ends of the inlet pipe (5) and the outlet pipe (6) both pass through the sealing plug (4) and connect to the connecting passage (2),
wherein a sump (7) is provided at an outer bottom wall of the connecting passage (2),
wherein a first drainage ditch (8) is provided along the circumference of a top edge of the sealing plug (4) within the shaft (3), and the first drainage ditch (8) is connected to the sump (7) via a first drainage pipe (9),
wherein a drainage blind pipe assembly is provided on an outer surface of the underground-gas-storage-chamber segments (101), and the drainage blind pipe assembly is connected to the sump (7) via a second drainage ditch (10) provided at the outer bottom wall of the connecting passage (2).

2. The underground gas storage device for compressed air energy storage according to claim 1, wherein the underground-gas-storage-chamber segments (101) are cylindrical, wherein adjacent underground-gas-storage-chamber segments (101) are integrally connected with an arcuate connection, and the connecting passage (2) is integrally connected to the corresponding underground-gas-storage-chamber segments (101).

3. The underground gas storage device for compressed air energy storage according to claim 1, wherein the inlet pipe (5) is a three-way pipe, including a vertically arranged first section of inlet pipe and two horizontally arranged second sections of inlet pipe,
wherein an upper part of the first section of inlet pipe is located within the shaft (3) and a lower part of the first section of inlet pipe is located within the sealing plug
wherein the sealing plug (4) is at the lower part of the shaft (3),
wherein one of the second sections of inlet pipe is situated within one side of the sealing plug (4), and the other one of the second sections of inlet pipeline is situated within the other side of the sealing plug (4),
wherein one end of each second section of inlet pipe is connected to a lower end of the first section of inlet pipe, and the other end of each second section of inlet pipe passes through the sealing plug (4) and communicates with the connecting passage (2).

4. The underground gas storage device for compressed air energy storage according to claim 3, wherein the outlet pipe (6) has the same structure as the inlet pipe (5), the outlet pipe (6) includes a vertically arranged first section of outlet pipe (601) and two horizontally arranged second sections of outlet pipe (602),
wherein the outlet pipe (6) is further used as an inspection pipe, an inspection port is provided at the first section of outlet pipe (601) near a top surface of the sealing plug (4), and the inspection port is equipped with a blocking blind plate (11).

5. The underground gas storage device for compressed air energy storage according to claim 1, wherein a second drainage pipe (12) is also provided within the shaft (3), a lower end of the second drainage pipe (12) extends into the sump (7) and an upper end of the second drainage pipe (12) extends to a surface of the ground and is connected to a pump.

6. The underground gas storage device for compressed air energy storage according to claim 5, wherein the sump (7) is located at the outer bottom wall of the connecting passage (2), which is located below the shaft (3),
wherein the first drainage pipe (9) passes through the sealing plug (4) and a lower end of the first drainage pipe (9) extends into the sump (7),
wherein the second drainage ditch (10) is arranged along an extension direction of the connecting passage (2) and is provided on the outer bottom wall of the connecting passage (2), and a lower part of the second drainage pipe (12) passes through the sealing plug (4).

7. The underground gas storage device for compressed air energy storage according to claim 1, wherein the drainage blind pipe assembly includes multiple circumferential drainage blind pipes (13) and multiple longitudinal drainage blind pipes (14),
wherein the circumferential drainage blind pipes (13) are arranged circumferentially around the outer surface of the underground-gas-storage-chamber segments (101),
wherein axes of the longitudinal drainage blind pipes (14) are parallel to axes of the underground-gas-storage-chamber segments (101) and are positioned at corresponding locations on the outer surface of the underground-gas-storage-chamber segments (101),
wherein the longitudinal drainage blind pipes (14) located at a bottom of the outer surface of the underground-gas-storage-chamber segments (101) are referred to as bottom longitudinal drainage blind pipes (15),
wherein each circumferential drainage blind pipe (13) is connected to each longitudinal drainage blind pipe (14), and the bottom longitudinal drainage blind pipes (15) of the underground-gas-storage-chamber segments (101) that are connected to the connecting passage (2) are connected to the second drainage ditch (10).

8. The underground gas storage device for compressed air energy storage according to claim 7, wherein an elevation of a bottom of two ends of the underground-gas-storage-chamber segments (101) that are connected to the connecting passage (2) is higher than an elevation at a bottom of points where the underground-gas-storage-chamber segments (101) are connected to the connecting passage (2).

9. The underground gas storage device for compressed air energy storage according to claim 1, wherein the underground-gas-storage-chamber segments (101) comprise, from outside to inside, a sprayed concrete layer (1011), a reinforced concrete lining layer (1012), and a sealing layer (1013), wherein the sealing layer (1013) is formed by sequentially welding multiple steel plates.

10. A construction method for the underground gas storage device for compressed air energy storage according to claim 1, comprising:
S1, forming the shaft (3) by excavation;
after the shaft (3) is completed, forming the connecting passage (2) along two directions of the shaft (3) by excavation, wherein the shaft (3) serves as a center of the connecting passage (2);
forming the sump (7) at an outer bottom wall of the connecting passage (2) and forming the second drainage ditch (10) along the outer bottom wall of the connecting passage (2);
after the connecting passage (2) is completed, forming the underground-gas-storage-chamber segments (101) that are connected to the connecting passage (2) by excavation; then, forming the underground-gas-storage-chamber segments (101) that are not connected to the connecting passage (2) by excavation;
arranging the drainage blind pipe assembly around an outer circumference of the underground-gas-storage-chamber segments (101) and connecting the drainage blind pipe assembly to the second drainage ditch (10);
S2, after all the underground-gas-storage-chamber segments (101) are excavated, constructing the sprayed concrete layer (1011), the reinforced concrete lining layer (1012), and the sealing layer (1013) from outside to inside of the underground-gas-storage-chamber segments (101);
providing the sealing plug (4) at the intersection of the shaft (3) and the connecting passage (2);
providing the inlet pipe (5) and the outlet pipe (6) within the shaft (3), wherein lower ends of the inlet pipe (5) and the outlet pipe (6) pass through the sealing plug (4) and communicate with the connecting passage (2);
connecting the first drainage ditch (8) disposed along a circumference of a top edge of the sealing plug (4) within the shaft (3) to the sump (7) via the first drainage pipe (9).
